(19) United States
(12) Patent Application Publication
(10) Pub. No.: US 2022/0135051 A1
(43) Pub. Date: May 5, 2022

(54) DRIVING ASSISTANCE SYSTEM AND DRIVING ASSISTANCE METHOD

(71) Applicant: HITACHI TRANSPORT SYSTEM, LTD., Tokyo (JP)

(72) Inventors: Hirofumi NAGASUKA, Tokyo (JP); Daichi OJIRO, Tokyo (JP); Hiroyuki KURIYAMA, Tokyo (JP); Kiminori SATO, Tokyo (JP); Yuhi SHINOHARA, Tokyo (JP)

(73) Assignee: HITACHI TRANSPORT SYSTEM, LTD., Tokyo (JP)

(21) Appl. No.: 17/431,362

(22) PCT Filed: Feb. 3, 2020
(86) PCT No.: PCT/JP2020/003888

§ 371 Date: Aug. 16, 2021

(30) Foreign Application Priority Data
Feb. 18, 2019 (JP) 2019-026229

(51) Int. Cl. B60W 40/09; B60W 50/14

(52) U.S. Cl. CPC B60W 40/09; B60W 50/14; B60W 2050/146; B60W 2540/21; B60W 2554/4048; B60W 2540/229

(57) ABSTRACT

A driving assistance system includes a processor, a storage device, and an output device. The storage device retains traveling environment information indicating a traveling environment of a vehicle and driving characteristic information indicating driving characteristics of a driver of the vehicle. The processor generates a message corresponding to the traveling environment of the vehicle based on the traveling environment information, and generates a message corresponding to the driving characteristics of the driver of the vehicle based on the driving characteristic information. The output device outputs the message corresponding to the traveling environment and the message corresponding to the driving characteristics in different aspects.

### CROSS-REFERENCE TO RELATED APPLICATION

This application is based upon and claims the benefit of priority from Japanese Patent Application No. 2019-026229, filed on Feb. 18, 2019; the entire contents of which are incorporated herein by reference.

### TECHNICAL FIELD

The present invention relates to a technique for assisting driving of a vehicle.

### BACKGROUND ART

As a technique for assisting driving of a vehicle such as an automobile, for example, there is JP 2017-68673 A (PTL 1). PTL 1 discloses that “a driving assistance apparatus according to an embodiment includes a recognition processing unit that recognizes a surrounding situation of a vehicle, a driving assistance processing unit that executes driving assistance control according to the surrounding situation of the vehicle recognized by the recognition processing unit, a display processing unit that displays a change in the surrounding situation of the vehicle on a display unit when the surrounding situation of the vehicle changes, a detection processing unit that detects information regarding a line of sight of a driver of the vehicle, and an output processing unit that outputs a first notification notifying the driver that the surrounding situation of the vehicle changes by using another notification unit different from the display unit when the recognized situation changes, and outputs a second notification notifying the driver that the surrounding situation of the vehicle changes again by using the notification unit when it is not detected that the line of sight of the driver faces the display unit based on the detection result by the detection processing unit after the first notification is output”.

### CITATION LIST

### Patent Literature

PTL 1: JP 2017-68673 A

### SUMMARY OF INVENTION

### Technical Problem

Different kinds of pieces of information may be provided to the driver in order to assist driving of the vehicle. The different kinds of pieces of information are, for example, information on a traveling environment of the vehicle and information on characteristics of the driver. The former example is information provided regardless of who the driver is, such as a shape of a road, weather, and a traffic condition, and the latter example is information related to driving characteristics of the driver. The information related to the driving characteristics can be provided or cannot be provided and a content thereof can change depending on who the driver is. It may be desirable to provide such pieces of information to the driver in a form in which it is easy to distinguish the kinds. When timings at which such a plurality of kinds of pieces of information is provided overlap with each other, processing of giving priority to one of the timings may be required. However, PTL 1 does not disclose that the different kinds of pieces of information are provided.

### Solution to Problem

In order to solve at least one of the above problems, a representative example of inventions disclosed in the present application is a driving assistance system including a processor, a storage device, and an output device. The storage device retains traveling environment information indicating a traveling environment of a vehicle and driving characteristic information indicating driving characteristics of a driver of the vehicle, the processor generates a message corresponding to the traveling environment of the vehicle based on the traveling environment information, and generates a message corresponding to the driving characteristics of the driver of the vehicle based on the driving characteristic information, and the output device outputs the message corresponding to the traveling environment and the message corresponding to the driving characteristics in different aspects.

### Advantageous Effects of Invention

According to one aspect of the present invention, it is possible to easily determine which kind of message is a message provided by a driver during a driving operation. Other objects, configurations, and effects will be made apparent in the following descriptions of the embodiments.

### BRIEF DESCRIPTION OF DRAWINGS

FIG. 1 is a block diagram illustrating an example of a configuration of a driving assistance system according to an embodiment of the present invention.

FIG. 2 is a block diagram illustrating an example of a configuration of an instruction center according to the embodiment of the present invention.

FIG. 3 is a block diagram illustrating an example of a configuration of a driving assistance apparatus according to the embodiment of the present invention.

FIG. 4 is a functional block diagram illustrating an example of the configuration of the driving assistance apparatus according to the embodiment of the present invention.

FIG. 5 is an explanatory diagram illustrating an example of a message record retained by the driving assistance apparatus according to the embodiment of the present invention.

FIG. 6 is an explanatory diagram illustrating an example of a priority definition flag retained by the driving assistance apparatus according to the embodiment of the present invention.

FIG. 7 is a flowchart illustrating an example of processing of a traveling environment message transmission unit of the driving assistance apparatus according to the embodiment of the present invention.

FIG. 8 is a flowchart illustrating an example of processing of a driving characteristic message transmission unit of the driving assistance apparatus according to the embodiment of the present invention.

FIG. 9 is a flowchart illustrating an example of processing of a voice generation unit of the driving assistance apparatus according to the embodiment of the present invention.

### DESCRIPTION OF EMBODIMENTS

Hereinafter, an embodiment of the present invention will be described with reference to the drawings.

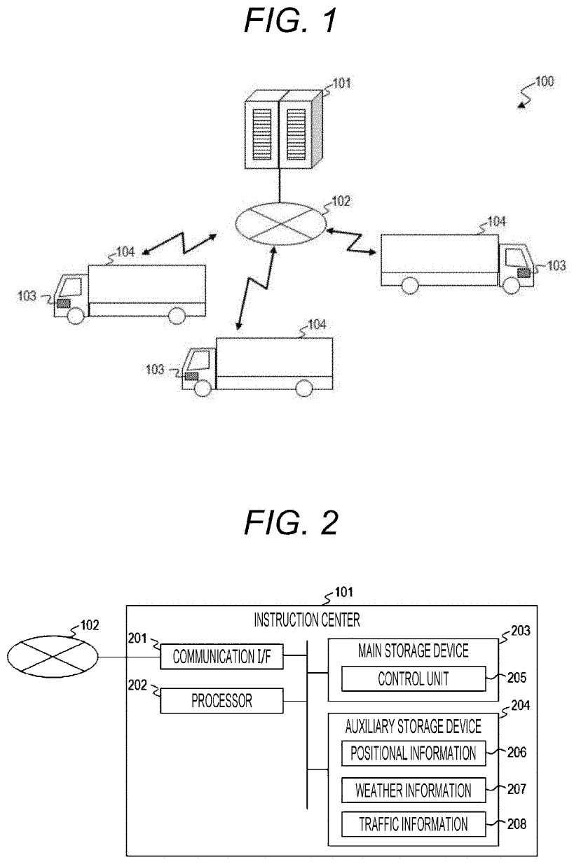

FIG. 1 is a block diagram illustrating an example of a configuration of a driving assistance system 100 according to the embodiment of the present invention.

The driving assistance system 100 of the present embodiment includes an instruction center 101, a network 102, and one or more driving assistance apparatuses 103 mounted on one or more vehicles 104. For example, one or more vehicles 104 may be a vehicle such as a truck managed by a transportation company or the like, and the instruction center 101 may be a center for the transportation company or the like to manage an operation of the truck or the like. Alternatively, the vehicle 104 may be a vehicle used in a passenger business such as a bus or a taxi, and the instruction center 101 may be an operation management center such as a business office.

FIG. 2 is a block diagram illustrating an example of a configuration of the instruction center 101 according to the embodiment of the present invention.

The instruction center 101 according to the present embodiment is a computer system including a communication interface 201, a processor 202, a main storage device 203, and an auxiliary storage device 204 connected to each other.

The communication interface 201 is connected to the network 102 and communicates with each driving assistance apparatus 103.

The processor 202 realizes various functions by executing programs stored in the main storage device 203. The main storage device 203 is, for example, a semiconductor storage device such as a DRAM, and the auxiliary storage device 204 is, for example, a relatively large-capacity storage device such as a hard disk drive or a flash memory. These storage devices store programs executed by the processor 202, data referred to by the processor 202, and the like.

In the example of FIG. 2, the control unit 205 is stored in the main storage device 203, and positional information 206, weather information 207, and traffic information 208 are stored in the auxiliary storage device 204. The control unit 205 is a program for realizing a function of the instruction center 101. Of course, the present invention is not limited to the example of FIG. 2, and an aspect may be used in which the control unit 205 is stored in the auxiliary storage device 204 side, at least a part thereof is stored in the main storage device 203 as necessary, and the control unit is referred to by the processor 202.

The positional information 206 is information indicating a position of each vehicle 104. The weather information 207 is information indicating the weather in each area. The traffic information 208 is, for example, information indicating a traffic condition such as a congestion condition of a road and presence or absence of a traffic regulation. At least a part of the positional information 206, the weather information 207, and the traffic information 208 may be stored in the main storage device 203 as necessary.

The function of the instruction center 101 realized by the control unit 205 is, for example, as follows. That is, the instruction center 101 collects the position of each vehicle 104 via the network 102 and stores the position as the positional information 206. The instruction center 101 may extract the weather and the traffic condition in the area including the position of each vehicle 104 from the weather information 207 and the traffic information 208, may generate an instruction for each vehicle 104 based on the extracted information, and may transmit the instruction to each vehicle 104 via the network 102. Alternatively, the instruction center 101 may transmit information on the weather and information on the traffic condition extracted from the weather information 207 and the traffic information 208 to each vehicle 104.

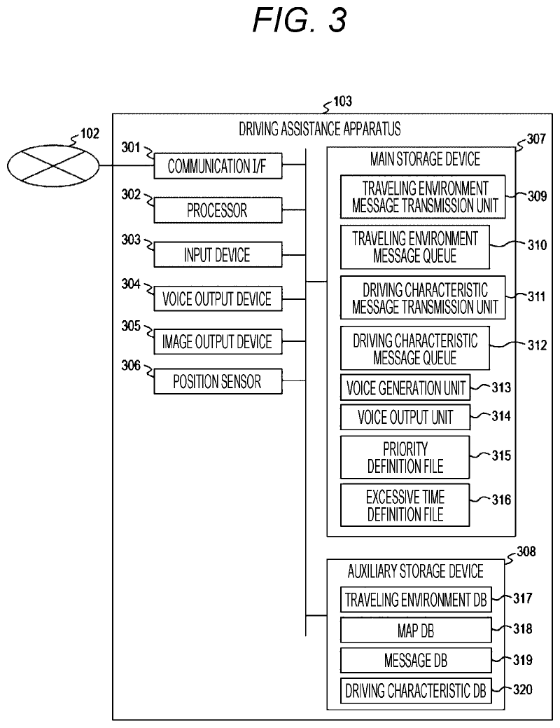

FIG. 3 is a block diagram illustrating an example of a configuration of the driving assistance apparatus 103 according to the embodiment of the present invention.

The driving assistance apparatus 103 according to the present embodiment is a computer system including a communication interface 301, a processor 302, an input device 303, a voice output device 304, an image output device 305, a position sensor 306, a main storage device 307, and an auxiliary storage device 308 connected to each other.

The communication interface 301 is connected to the network 102 and communicates with the instruction center 101.

The processor 302 realizes various functions by executing programs stored in the main storage device 307. The main storage device 307 is, for example, a semiconductor storage device such as a DRAM, and the auxiliary storage device 308 is, for example, a relatively large-capacity storage device such as a hard disk drive or a flash memory. These storage devices store programs executed by the processor 302, data referred to by the processor 302, and the like.

In the example of FIG. 3, a traveling environment message transmission unit 309, a traveling environment message queue 310, a driving characteristic message transmission unit 311, a driving characteristic message queue 312, a voice generation unit 313, a voice output unit 314, a priority definition file 315, and an excess time definition file 316 are stored in the main storage device 307. A traveling environment database (DB) 317, a map database 318, a message database 319, and a driving characteristic database 320 are stored in the auxiliary storage device 308. In the example of FIG. 3, the traveling environment database 317, the map database 318, the message database 319, and the driving characteristic database 320 are retained in the driving assistance apparatus 103, but these databases may be retained in an external storage device, a computer, or the like connected to the driving assistance apparatus 103.

The traveling environment message transmission unit 309, the driving characteristic message transmission unit 311, the voice generation unit 313, and the voice output unit 314 are programs for realizing the functions of the driving assistance apparatus 103. These programs may be stored in the auxiliary storage device 308, and at least a part thereof may be stored in the main storage device 307 as necessary and may be referred to by the processor 302.

The traveling environment message queue 310 and the driving characteristic message queue 312 retain and output message records (to be described later) including messages generated by the traveling environment message transmission unit 309 and the driving characteristic message transmission unit 311 in a generation order of the messages.

The priority definition file 315 retains a priority definition flag (to be described later) indicating which of a message corresponding to a traveling environment and a message corresponding to driving characteristics is prioritized. The excess time definition file 316 retains an excess time that is a condition for deleting an old message without outputting the old message.

The traveling environment database 317 stores information indicating the traveling environment of each vehicle 104. The information indicating the traveling environment may include, for example, a shape and topography of a road around a location of each vehicle 104, the weather and the traffic condition acquired from the instruction center 101, and the like. Alternatively, when there is information such as low visibility due to dust, in addition to a traveling time (daytime, nighttime, or the like), a traveling time such as a degree of glare due to morning sunlight or sunset and seasonal information, this information may be included.

The map database 318 stores map information of an area including at least a location and a destination of each vehicle 104. The map database 318 may include road sign information such as a legal speed and a temporary stop point attached to the map.

The message database 319 stores the messages generated by the traveling environment message transmission unit 309 and the driving characteristic message transmission unit 311. For example, a large number of messages may be stored in advance in the message database 319, and the traveling environment message transmission unit 309 and the driving characteristic message transmission unit 311 may generate the messages by selecting appropriate messages from the messages stored in advance.

The driving characteristic database 320 stores information indicating characteristics related to driving of a driver of each vehicle 104. The characteristics related to the driving of the driver are, for example, information indicating a propensity specific to the driver, such as a propensity to increase the speed or a propensity to decrease an inter-vehicle distance.

The input device 303 is a device that receives an input from a user of the driving assistance apparatus 103 (for example, the driver of the vehicle 104 on which the driving assistance apparatus 103 is mounted or a passenger thereof), and may be, for example, a microphone, a button, or a touch panel for voice input. The voice output device 304 is a device that outputs voice information to the user, and may include, for example, a speaker and an amplifier for driving the speaker. The image output device 305 is a device that outputs image information to the user, and may include, for example, a liquid crystal display.

The position sensor 306 is, for example, a Global Positioning System (GPS) terminal, and measures a position of the driving assistance apparatus 103 (that is, a position of the vehicle 104 on which the driving assistance apparatus is mounted). For example, the driving assistance apparatus 103 may periodically transmit the position measured by the position sensor 306 to the instruction center 101. In this case, the instruction center 101 retains, as the positional information 206, the position received from the driving assistance apparatus 103 of each vehicle 104. The driving assistance apparatus 103 may further include any kind of sensor such as a camera that captures the surroundings of the vehicle 104, or may receive information from a similar sensor installed in the vehicle 104 via the network 102.

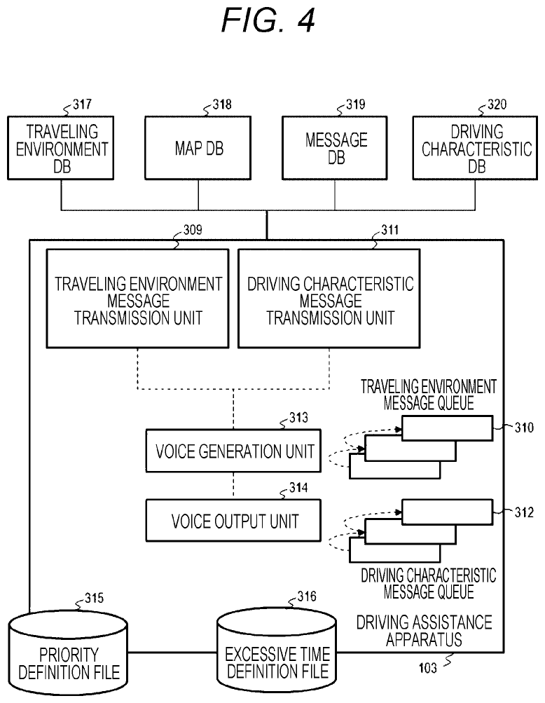

FIG. 4 is a functional block diagram illustrating an example of the configuration of the driving assistance apparatus 103 according to the embodiment of the present invention.

In FIG. 4, the traveling environment message transmission unit 309, the driving characteristic message transmission unit 311, the voice generation unit 313, and the voice output unit 314 indicate functions realized by the processor 302 executing the programs stored in the main storage device 307. In the following description, tasks of processing executed by these units are actually executed by the processor 302 controlling the units of the driving assistance apparatus 103 as necessary according to the programs stored in the main storage device 307.

As illustrated in FIG. 4, the traveling environment message transmission unit 309 and the driving characteristic message transmission unit 311 generate the messages to be output. The generated messages are stored in the traveling environment message queue 310 and the driving characteristic message queue 312. The voice generation unit 313 generates voice to read the generated message, and the voice output unit 314 outputs the voice.

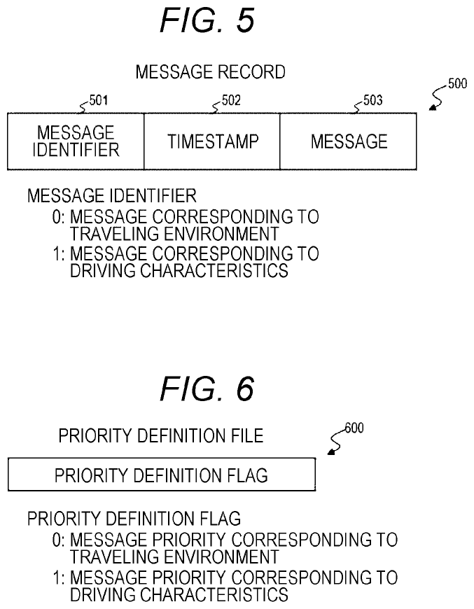

FIG. 5 is an explanatory diagram illustrating an example of the message record retained by the driving assistance apparatus 103 according to the embodiment of the present invention.

A message record 500 of the present embodiment includes a message identifier 501, a timestamp 502, and a message 503. The message 503 is a message generated by the traveling environment message transmission unit 309 or the driving characteristic message transmission unit 311. The message identifier 501 indicates whether the message 503 is the message corresponding to the traveling environment or the message corresponding to the driving characteristics, that is, whether the message is generated by the traveling environment message transmission unit 309 or the driving characteristic message transmission unit 311. For example, values “0” and “1” of the message identifier 501 indicate the message corresponding to the traveling environment and the message corresponding to the driving characteristics indicated by the message 503, respectively. The timestamp 502 indicates a time at which the message 503 is generated.

The message record 500 in which the value of the message identifier 501 is “0” is stored in the traveling environment message queue 310, and the message record 500 in which the value of the message identifier 501 is “1” is stored in the driving characteristic message queue 312. A plurality of message records 500 may be stored in each of the traveling environment message queue 310 and the driving characteristic message queue 312.

FIG. 6 is an explanatory diagram illustrating an example of the priority definition flag retained by the driving assistance apparatus 103 according to the embodiment of the present invention.

A priority definition flag 600 of the present embodiment is included in the priority definition file 315. A value “0” of the priority definition flag 600 indicates that the message corresponding to the traveling environment is prioritized, and a value “0” of the priority definition flag 600 indicates that the message corresponding to the driving characteristics is prioritized.

The value of the priority definition flag 600 is set in advance by, for example, an administrator of the instruction center 101 or a user of the driving assistance apparatus 103. For example, a high priority can be set for the message of the kind determined to have high importance. The value of the priority definition flag 600 may be different for each driving assistance apparatus 103. For example, the administrator of the instruction center 101 may set, in the priority definition flag 600, a value indicating that the message corresponding to the driving characteristics is prioritized for the driving assistance apparatus 103 used by a driver having a low driving proficiency level. Alternatively, the administrator of the instruction center 101 may set, in the priority definition flag 600, a value indicating that the message corresponding to the traveling environment is prioritized for the driving assistance apparatus 103 of the vehicle 104 scheduled to travel in a poor environment.

As will be described later, important information can be reliably delivered to the user by preferentially outputting the message of the kind having the high priority according to the priority definition flag 600 set in this manner.

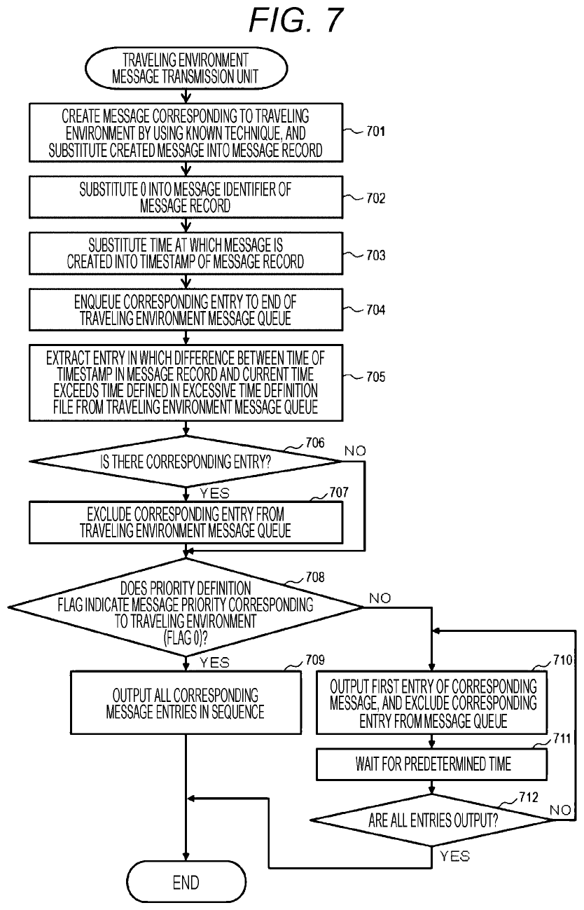

FIG. 7 is a flowchart illustrating an example of processing of the traveling environment message transmission unit 309 of the driving assistance apparatus 103 according to the embodiment of the present invention.

First, the traveling environment message transmission unit 309 creates the message corresponding to the traveling environment, and substitutes the created message into a new message record 500 (step 701). Since this message can be created by any method such as a known technique, detailed description thereof is omitted.

For example, based on a current location of the vehicle 104 detected by the position sensor 306 and a route from the current location to the destination, the traveling environment message transmission unit 309 may search the traveling environment database 317 for information on the current location or the traveling environment of a point to pass from now on, may acquire the message corresponding to the traveling environment from the message database 319, and may substitute the message into the message record 500.

Specifically, for example, as the information on the traveling environment, information regarding the topography or the shape of the road such as a steep uphill, a steep downhill, or a sharp curve in a traveling direction may be acquired, information regarding the traffic condition such as the occurrence of the traffic congestion or the traffic regulation in the traveling direction may be acquired, or information regarding the weather such as rainfall or snowfall being expected may be acquired. Alternatively, such a message may be acquired at a point where accidents, falling objects, jumping out, or the like frequently occur based on past road information. Alternatively, in the nighttime, a message for prompting lighting of a headlight or calling attention regarding a speed limit or road sign information may be acquired. The traveling environment message transmission unit 309 may generate a message for notifying of the acquired information, or may further generate a message for calling attention regarding the driving of the vehicle 104 (for example, attention to the front or speed reduction) in accordance with the acquired information.

Subsequently, the traveling environment message transmission unit 309 substitutes the value (“0” in the present embodiment) indicating that the message is the message corresponding to the traveling environment into the message identifier 501 of the message record 500 (step 702).

Subsequently, the traveling environment message transmission unit 309 substitutes the time at which the message is created into the timestamp 502 of the message record 500 (step 703).

Subsequently, the traveling environment message transmission unit 309 enqueues the message record 500 to an end of the traveling environment message queue 310 (step 704).

Subsequently, the traveling environment message transmission unit 309 extracts the message record 500 in which a difference between a value of the timestamp 502 and the current time exceeds a time defined in the excess time definition file 316 from all the message records 500 of the traveling environment message queue 310 (step 705).

Subsequently, the traveling environment message transmission unit 309 determines whether or not at least one message record 500 has been extracted in step 705 (step 706), and deletes the message record 500 from the traveling environment message queue 310 (step 707) when one message record has been extracted (step 706: YES). On the other hand, when no message record 500 has been extracted in step 705 (step 706: NO), step 707 is not executed.

Step 705 to step 707 are executed, and thus, the old message record 500 is deleted. Accordingly, the output of the old message that no longer needs to be output is prevented.

In the present embodiment, as described above, the determination as to whether or not to delete the message is performed based on an elapsed time after the message is created, but this example is an example of a message deletion criterion (deletion condition), and another criterion may be used. For example, when the message 503 included in a certain message record 500 is associated with a specific point such as a sharp curve or a traffic regulation and the message record 500 remains without being output even after the vehicle 104 passes through the corresponding point, the message record 500 may be deleted. Alternatively, the message record 500 regarding the weather may be deleted when weather forecast changes before this message record is output.

As described above, even though a message is generated since it is determined to need to be output, when the determination is changed that there is no need to output the message due to a subsequent change in a situation, it is possible to prevent confusion of the driver due to the output of an unnecessary message by deleting the message.

Subsequently, the traveling environment message transmission unit 309 determines whether or not the priority definition flag 600 is the value (“0” in the present embodiment) indicating that the message corresponding to the traveling environment is prioritized (step 708). When the priority definition flag 600 is the value indicating that the message corresponding to the traveling environment is prioritized (step 708: YES), the traveling environment message transmission unit 309 outputs all the message records 500 stored in the traveling environment message queue 310 to the voice generation unit 313 in the enqueued order, and deletes these message records 500 from the traveling environment message queue 310 (step 709).

On the other hand, when the priority definition flag 600 is not the value indicating that the message corresponding to the traveling environment is prioritized (step 708: NO), the traveling environment message transmission unit 309 outputs the first message record 500 in the traveling environment message queue 310 to the voice generation unit 313, deletes the message record 500 from the traveling environment message queue 310 (step 710), and waits for a predetermined time (step 711). Accordingly, when the plurality of message records 500 is stored in the traveling environment message queue 310, the next message record 500 is not output for the predetermined time.

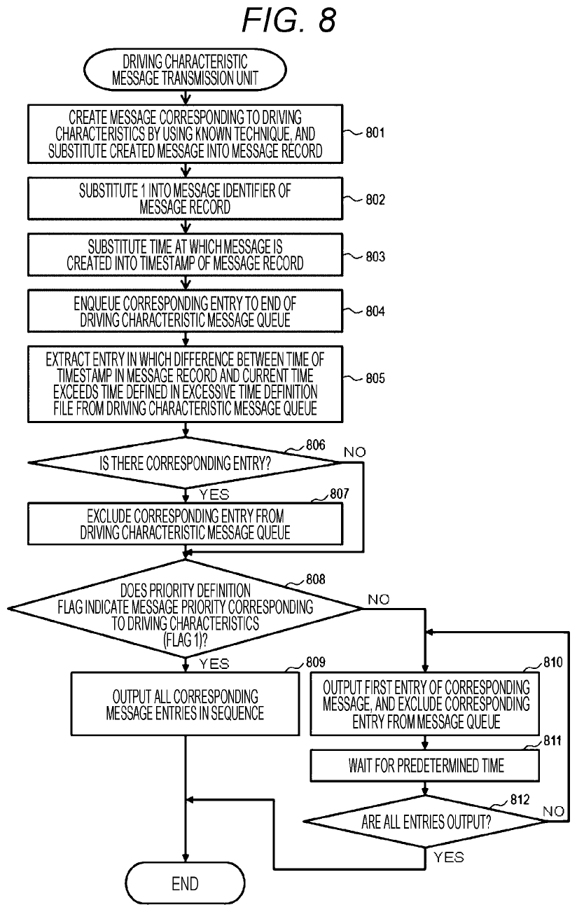

In the present embodiment, the determination in step 708 that the priority definition flag 600 is not the value indicating that the message corresponding to the traveling environment is prioritized means that the message corresponding to the driving characteristics is prioritized. In this case, while the traveling environment message transmission unit 309 waits in step 711, the driving characteristic message transmission unit 311 can output the message corresponding to the driving characteristics. At this time, when the plurality of message records is stored in the driving characteristic message queue 312, all the message records are output (see step 809 in FIG. 8 to be described later). Accordingly, the message corresponding to the driving characteristics is preferentially output according to the definition by the priority definition flag 600. As a result, for example, when a large number of messages are generated in a short time, it is possible to prevent the output of an important message from failing.

After the traveling environment message transmission unit 309 waits for the predetermined time in step 711, the traveling environment message transmission unit 309 determines whether all the message records 500 in the traveling environment message queue 310 have been output (step 712). When there is the message record 500 that has not yet been output (step 712: NO), the processing returns to step 710.

When all the message records 500 have been output in step 709 and when it is determined that all the message records 500 have been output in step 712 (step 712: YES), the traveling environment message transmission unit 309 ends the processing.

FIG. 8 is a flowchart illustrating an example of processing of the driving characteristic message transmission unit 311 of the driving assistance apparatus 103 according to the embodiment of the present invention.

First, the driving characteristic message transmission unit 311 creates the message corresponding to the driving characteristics and substitutes the created message into the new message record 500 (step 801). Since this message can be created by any method such as a known technique, detailed description thereof is omitted.

For example, the driving characteristic message transmission unit 311 may acquire information indicating the driving characteristics of the driver of the vehicle 104 from driving characteristic database 320, may acquire the message corresponding to the driving characteristics from the message database 319, and may substitute the message into the message record 500. At this time, the driving characteristic message transmission unit 311 may use the information on the current location or the traveling environment of the point to pass from now on which is searched from the traveling environment database 317 based on the current location of the vehicle 104 detected by the position sensor 306 and the route from the current location to the destination.

Specifically, for example, when information indicating that the driver has a propensity to increase the speed of the vehicle 104 is obtained as the driving characteristics of the driver of the vehicle 104 from the driving characteristic database 320 and it is determined that there is a sharp curve, a long downhill, or the like in the traveling direction from the position of the vehicle 104 and the route to the destination, the driving characteristic message transmission unit 311 may generate a message for calling attention so as to suppress the speed. Alternatively, a time zone in which a decrease in concentration or accumulation of fatigue occurs as a driving time elapses may be predicted, and a message for calling attention may be generated. A message notifying of a next travel route for each time or base, or a message prompting acquisition of a break may be generated in accordance with an operation plan of the day.

Subsequently, the driving characteristic message transmission unit 311 substitutes the value (“1” in the present embodiment) indicating that the message is the message corresponding to the driving characteristics into the message identifier 501 of the message record 500 (step 802).

Subsequently, the driving characteristic message transmission unit 311 substitutes the time at which the message is created into the timestamp 502 of the message record 500 (step 803).

Subsequently, the driving characteristic message transmission unit 311 enqueues the message record 500 to the end of the driving characteristic message queue 312 (step 804).

Subsequently, the driving characteristic message transmission unit 311 extracts the message record 500 in which the difference between the value of the timestamp 502 and the current time exceeds the time defined in the excess time definition file 316 from all the message records 500 of the driving characteristic message queue 312 (step 805).

Subsequently, the driving characteristic message transmission unit 311 determines whether at least one message record 500 has been extracted in step 805 (step 806), and deletes the message record 500 from the driving characteristic message queue 312 (step 807) when the message record has been extracted (step 806: YES). On the other hand, when no message record 500 has been extracted in step 805 (step 806: NO), step 807 is not executed.

Step 805 to step 807 are executed, and thus, the old message record 500 is deleted. Accordingly, the output of the old message that no longer needs to be output is prevented.

A case where the message that does not need to be output may be extracted based on a criterion other than the elapsed time is similar to a case where the message record 500 is deleted from the traveling environment message queue 310.

Subsequently, the driving characteristic message transmission unit 311 determines whether or not the priority definition flag 600 is the value (“1” in the present embodiment) indicating that the message corresponding to the driving characteristics is prioritized (step 808). When the priority definition flag 600 is the value indicating that the message corresponding to the driving characteristics is prioritized (step 808: YES), the driving characteristic message transmission unit 311 outputs all the message records 500 stored in the driving characteristic message queue 312 to the voice generation unit 313 in the enqueued order, and deletes these message records 500 from the driving characteristic message queue 312 (step 809).

On the other hand, when the priority definition flag 600 is not the value indicating that the message corresponding to the driving characteristics is prioritized (step 808: NO), the driving characteristic message transmission unit 311 outputs the first message record 500 of the driving characteristic message queue 312 to the voice generation unit 313, deletes the message record 500 from the driving characteristic message queue 312 (step 810), and waits for a predetermined time (step 811). Accordingly, when the plurality of message records 500 is stored in the driving characteristic message queue 312, the next message record 500 is not output for the predetermined time.

In the present embodiment, the determination in step 808 that the priority definition flag 600 is not the value indicating that the message corresponding to the driving characteristics is prioritized means that the message corresponding to the traveling environment is prioritized. In this case, while the driving characteristic message transmission unit 311 waits in step 811, the traveling environment message transmission unit 309 can output the message corresponding to the traveling environment. At this time, when the plurality of message records is stored in the driving characteristic message queue 312, all the message records are output (step 709 in FIG. 7). Accordingly, the message corresponding to the traveling environment is preferentially output according to the definition of the priority definition flag 600. As a result, for example, when a large number of messages are generated in a short time, it is possible to prevent the output of an important message from failing.

After the driving characteristic message transmission unit 311 waits for the predetermined time in step 811, the driving characteristic message transmission unit 311 determines whether all the message records 500 of the driving characteristic message queue 312 have been output (step 812). When there is the message record 500 that has not yet been output (step 812: NO), the processing returns to step 810.

When all the message records 500 are output in step 809 and when it is determined that all the message records 500 are output in step 812 (step 812: YES), the driving characteristic message transmission unit 311 ends the processing.

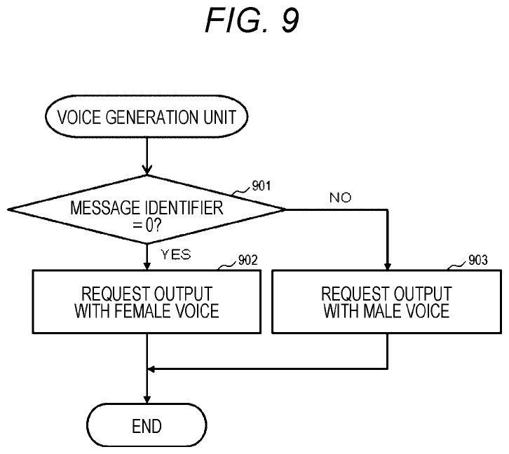

FIG. 9 is a flowchart illustrating an example of processing of the voice generation unit 313 of the driving assistance apparatus 103 according to the embodiment of the present invention.

When the message record 500 output from the traveling environment message transmission unit 309 or the driving characteristic message transmission unit 311 is received, the voice generation unit 313 determines whether or not the message identifier 501 of the message record 500 is “0” (step 901).

When the message identifier 501 is “0” (step 901: YES), the message 503 of the message record 500 is the message corresponding to the traveling environment. In this case, the voice generation unit 313 requests the output of a message with female voice (step 902). Specifically, the voice generation unit 313 may generate voice data to read the message 503 with female voice and output the voice data to the voice output unit 314. The voice output unit 314 outputs the voice to read the message 503 with female voice by using the voice data to the voice output device 304.

On the other hand, when the message identifier 501 is not “0” (that is, “1”) (step 901: NO), the message 503 of the message record 500 is the message corresponding to the driving characteristics. In this case, the voice generation unit 313 requests the output of a message with male voice (step 903). Specifically, the voice generation unit 313 may generate voice data to read the message 503 with male voice, and may output the voice data to the voice output unit 314. The voice output unit 314 outputs the voice to read the message 503 with male voice by using the voice data to the voice output device 304.

The method for generating the voice to read the message corresponding to the traveling environment with female voice and generating the voice to read the message corresponding to the driving characteristics with male voice is an example of a method for outputting these messages in different aspects, and these messages may be output by different methods, respectively, and a difference between male and female may not be essential. For example, the difference in the aspect may be at least one of a difference in person who speaks the voice of the message, a difference in frequency of the voice of the message, a difference in tone of the voice of the message, a difference in voice added to the message, and a difference in vibration added to the message.

Specifically, for example, the voice generation unit 313 may generate the voice to read both the message corresponding to the traveling environment and the message corresponding to the driving characteristics with male (or female) voice. At that time, the tone of the voice to read may be changed according to the kind of the message. For example, the voice generation unit 313 may generate the voice to read the message corresponding to the traveling environment in a calm tone, and may generate the voice to read the message corresponding to the driving characteristics in a strong tone. Furthermore, a message from a family member of the driver recorded in advance may be generated.

Alternatively, when one kind of message is output, the voice output unit 314 may additionally output a warning sound, or may additionally output vibration or the like due to the vibrator when the driving assistance apparatus 103 includes a vibrator or the like (not illustrated).

An aspect in which such a message is output may be decided based on the priority of the message instead of the kind of the message (that is, whether the message corresponds to the traveling environment or the driving characteristics). For example, when the priority definition flag 600 is the value indicating that the message corresponding to the traveling environment is prioritized, the voice generation unit 313 may generate the voice to read the message corresponding to the traveling environment with male voice, and may generate the voice to read the message corresponding to the driving characteristics with female voice.

In the above embodiment, although the example has been described in which the message is output as the voice, the image output device 305 may output the message as a text image. At this time, the image output device 305 may change a display aspect, for example, a color, a size, or a typeface of characters, or a symbol, a photograph, a figure, or the like to be incidentally displayed, according to the kind of the message (that is, whether the message corresponds to the traveling environment or the driving characteristics).

According to the embodiment of the present invention described above, even when a plurality of kinds of messages are output in a mixed manner, the aspect of the output is changed according to the kind of the message to be output, and thus, the user (for example, the driver of the vehicle 104) can receive and utilize the messages without being confused. It is possible to reliably deliver an important message to the user even when a large number of messages are output in a short time by setting the priority according to the kind of the message and controlling the output of the message according to the priority.

In the above embodiment, the instruction center 101 retains the weather information 207 and the traffic information 208 and transmits the pieces of information to the driving assistance apparatus 103 as necessary. However, the instruction center 101 may acquire these pieces of information from an external server (for example, neither a weather information server nor a traffic information server is illustrated) connected to the network 102. Alternatively, the driving assistance apparatus 103 may acquire necessary information from these external servers via the network 102 without using the instruction center 101. Accordingly, the latest information can be used as the traveling environment information.

In the above embodiment, the example has been described in which the traveling environment message transmission unit 309, the driving characteristic message transmission unit 311, and the voice generation unit 313 are provided in the driving assistance apparatus 103 which is a part of the driving assistance system 100. However, these units may be provided in other parts in the driving assistance system 100. For example, at least a part of these units may be provided in the instruction center 101. In this case, the traveling environment database 317, the map database 318, the message database 319, and the driving characteristic database 320 are also retained in the instruction center 101. For example, the instruction center 101 may transmit the generated voice data to the driving assistance apparatus 103, and the voice output unit 314 of the driving assistance apparatus 103 may output the voice based on the voice data to the voice output device 304.

However, since the traveling environment message transmission unit 309, the driving characteristic message transmission unit 311, and the voice generation unit 313 are provided in the driving assistance apparatus 103, the output of the message from the driving assistance apparatus 103 to the user (for example, the driver of the vehicle 104) is less likely to be affected by the congestion or the like of the network 102.

The present invention is not limited to the aforementioned embodiment, and includes various modification examples. For example, the aforementioned embodiment is described in detail in order to facilitate easy understanding of the present invention, and is not limited to necessarily include all the components of the description.

For example, the information stored in the traveling environment database 317 and the information stored in the driving characteristic database 320 of the present embodiment are examples of pieces of information for assisting two or more kinds of driving, and the driving assistance apparatus 103 may retain information for assisting driving other than the above pieces of information. In this case, similarly to the traveling environment message transmission unit 309 and the driving characteristic message transmission unit 311, the driving assistance apparatus 103 includes transmission units of messages corresponding to different kinds of pieces of information, and generates messages corresponding to the kinds of pieces of information.

For example, when the vehicle 104 has a sensor such as a camera that captures an image of the surroundings, one of the pieces of information for assisting two or more kinds of driving may be information obtained from the sensor, and the other information may be information provided from the instruction center 101 or another external server. In this example, the information provided from the instruction center 101 and the information provided from another external server may be handled as different kinds of pieces of information.

The transmission units of the messages corresponding to the different kinds of pieces of information generate messages corresponding to the kinds of pieces of information. The voice generation unit 313 generates voice data (for example, voice data spoken with voices of persons of different genders, data spoken with voices of different tones, or the like for each kind of information) for outputting the messages corresponding to the kinds of pieces of information in different aspects, and the voice output unit 314 outputs voice based on the voice data.

Apart or all of the aforementioned configurations, functions, processing units, and processing means may be realized by hardware by designing an integrated circuit, for example. Each of the aforementioned configurations and functions may be realized by software by interpreting and executing a program that realizes each function by the processor. Information of programs, tables, and files for realizing the functions can be stored in a storage device such as a nonvolatile semiconductor memory, a hard disk drive, or a solid state drive (SSD), or a computer-readable non-transitory data storage medium such as an IC card, an SD card, or a DVD.

Control lines and information lines illustrate lines which are considered to be necessary for the description, and all the control lines and information lines in a product are not necessarily illustrated. Almost all the configurations may be considered to be actually connected to each other.

1. A driving assistance system, comprising:
a processor;
a storage device; and
an output device,
wherein the storage device retains traveling environment information indicating a traveling environment of a vehicle and driving characteristic information indicating driving characteristics of a driver of the vehicle,
the processor
generates a message corresponding to the traveling environment of the vehicle based on the traveling environment information, and
generates a message corresponding to the driving characteristics of the driver of the vehicle based on the driving characteristic information, and
the output device outputs the message corresponding to the traveling environment and the message corresponding to the driving characteristics in different aspects.

2. The driving assistance system according to claim 1, wherein the different aspects are at least one of a difference in person who speaks voice of the message, a difference in frequency of the voice of the message, a difference in tone of the voice of the message, a difference in voice added to the message, and a difference in vibration added to the message.

3. The driving assistance system according to claim 2,
wherein the processor
generates the message corresponding to the traveling environment as a voice message with voice of one of male and female, and
generates the message corresponding to the driving characteristics as a voice message with voice of the other one of the male and female, and
the output device outputs the message corresponding to the traveling environment and the message corresponding to the driving characteristics in different aspects by outputting the voice message with the voice of the male or female generated by the processor.

4. The driving assistance system according to claim 1,
wherein the storage device retains priority information indicating which of the message corresponding to the traveling environment and the message corresponding to the driving characteristics has a higher priority, and
the processor causes the output device to output preferentially the message with the higher priority according to the priority information when both the message corresponding to the traveling environment and the message corresponding to the driving characteristics are generated.

5. The driving assistance system according to claim 4,
wherein the processor
stores, when the message corresponding to the traveling environment is generated, the message corresponding to the traveling environment in a traveling environment message queue in the storage device, and
causes the output device to output, when one or more messages corresponding to the traveling environment are stored in the traveling environment message queue and the priority of the message corresponding to the traveling environment is high, all the messages corresponding to the traveling environment stored in the traveling environment message queue,
causes the output device to output the first message corresponding to the traveling environment stored in the traveling environment message queue and then causes the output device not to output a next message corresponding to the traveling environment for a predetermined time when the one or more messages corresponding to the traveling environment are stored in the traveling environment message queue and the priority of the message corresponding to the traveling environment is not high,
stores, when the message corresponding to the driving characteristics is generated, the message corresponding to the driving characteristics in a driving characteristic message queue in the storage device,
causes the output device to output, when one or more messages corresponding to the driving characteristics are stored in the driving characteristic message queue and the priority of the message corresponding to the driving characteristics is high, all the messages corresponding to the driving characteristics stored in the driving characteristic message queue, and
causes the output device to output a first message corresponding to the driving characteristics stored in the driving characteristic message queue and then causes the output device not to output a next message corresponding to the driving characteristics for a predetermined time when the one or more messages corresponding to the driving characteristics are stored in the driving characteristic message queue and the priority of the message corresponding to the driving characteristics is not high.

6. The driving assistance system according to claim 5, wherein the processor deletes a message satisfying a predetermined deletion condition among the messages corresponding to the traveling environment stored in the traveling environment message queue and the messages corresponding to the driving characteristics stored in the driving characteristic message queue.

7. The driving assistance system according to claim 1, further comprising:
a communication interface connected to a network,
wherein the driving assistance system is mounted on the vehicle, and
the traveling environment information includes information regarding at least one of weather and a traffic condition acquired via the network.

8. A driving assistance system, comprising:
a processor;
a storage device; and
an output device,
wherein the storage device retains pieces of information for assisting two or more kinds of driving,
the processor generates messages corresponding to the pieces of information for assisting the two or more kinds of driving, and
the output device outputs the messages corresponding to the pieces of information for assisting the two or more kinds of driving in different aspects for kinds of the pieces of information.

9. A driving assistance method executed by a driving assistance system including a processor, a storage device, and an output device,
wherein the storage device retains traveling environment information indicating a traveling environment of a vehicle and driving characteristic information indicating driving characteristics of a driver of the vehicle, and the driving assistance method includes
a first procedure of generating, by the processor, a message corresponding to
the traveling environment of the vehicle based on the traveling environment information,
a second procedure of generating, by the processor, a message corresponding to the driving characteristics of the driver of the vehicle based on the driving characteristic information, and
a third procedure of outputting, by the output device, the message corresponding to the traveling environment and the message corresponding to the driving characteristics in different aspects.

10. The driving assistance method according to claim 9, wherein the different aspects are at least one of a difference in person who speaks voice of the message, a difference in frequency of the voice of the message, a difference in tone of the voice of the message, a difference in voice added to the message, and a difference in vibration added to the message.

11. The driving assistance method according to claim 10,
wherein, in the first procedure, the processor generates the message corresponding to the traveling environment as a voice message with voice of one of male and female,
in the second procedure, the processor generates the message corresponding to the driving characteristics as a voice message with voice of the other one of the male and female, and
in the third procedure, the output device outputs the voice message with the voice of the male or female generated by the processor.

12. The driving assistance method according to claim 9,
wherein the storage device retains priority information indicating which of the message corresponding to the traveling environment and the message corresponding to the driving characteristics has a higher priority, and
in the first procedure and the second procedure, the processor causes the output device to output preferentially the message with the higher priority according to the priority information when both the message corresponding to the traveling environment and the message corresponding to the driving characteristics are generated.

13. The driving assistance method according to claim 12,
wherein, in the first procedure, the processor
stores, when the message corresponding to the traveling environment is generated, the message corresponding to the traveling environment in a traveling environment message queue in the storage device, and
causes the output device to output, when one or more messages corresponding to the traveling environment are stored in the traveling environment message queue and the priority of the message corresponding to the traveling environment is high, all the messages corresponding to the traveling environment stored in the traveling environment message queue, and
causes the output device to output a first message corresponding to the traveling environment stored in the traveling environment message queue and then causes the output device not to output a next message corresponding to the traveling environment for a predetermined time when the one or more messages corresponding to the traveling environment are stored in the traveling environment message queue and the priority of the message corresponding to the traveling environment is not high, and
in the second procedure, the processor
stores, when the message corresponding to the driving characteristics is generated, the message corresponding to the driving characteristics in a driving characteristic message queue in the storage device,
causes the output device to output, when one or more messages corresponding to the driving characteristics are stored in the driving characteristic message queue and the priority of the message corresponding to the driving characteristics is high, all the messages corresponding to the driving characteristics stored in the driving characteristic message queue, and
causes the output device to output a first message corresponding to the driving characteristics stored in the driving characteristic message queue and then causes the output device not to output a next message corresponding to the driving characteristics for a predetermined time when the one or more messages corresponding to the driving characteristics are stored in the driving characteristic message queue and the priority of the message corresponding to the driving characteristics is not high.

14. The driving assistance method according to claim 13, wherein, in the first procedure and the second procedure, the processor deletes a message satisfying a predetermined deletion condition among the messages corresponding to the traveling environment stored in the traveling environment message queue and the messages corresponding to the driving characteristics stored in the driving characteristic message queue.

15. The driving assistance method according to claim 9,
wherein the driving assistance system further includes a communication interface connected to a network,
the driving assistance system is mounted on the vehicle, and
the traveling environment information includes information regarding at least one of weather and a traffic condition acquired via the network.
